(19) United States
(12) Patent Application Publication
(10) Pub. No.: US 2026/0208962 A1
(43) Pub. Date: Jul. 23, 2026

(54) FEEDERHOUSE BELT ARRANGEMENT

(71) Applicant: AGCO do Brasil Soluções Agrícolas Ltda., Jundiaí-São Paulo (BR)

(72) Inventors: Airton Solimar Walter, Canoas (BR); Lauro Bonetti, Canoas (BR)

(21) Appl. No.: 19/570,421

(22) Filed: Mar. 18, 2026

(30) Foreign Application Priority Data
Mar. 21, 2024 (GB) 2504195.5

(51) Int. Cl. B65G 19/24; A01D 57/20; A01D 61/00

(52) U.S. Cl. CPC B65G 19/24; A01D 57/20; A01D 61/008

(57) ABSTRACT

A feederhouse coupling arrangement between a slat and an endless belt for a feederhouse feed conveyor of an agricultural harvester is disclosed. The endless belt has a plurality of integrally formed teeth on a first side of the belt and the slat has first and second laterally aligned openings at each end. At least one of the plurality of teeth is formed with a shaped recess. First and second belt openings extend from the shaped recess to a second side of the belt, each of the first and second belt openings being aligned with the first and second slat openings. A shaped insert is located within the shaped recess and fasteners secure the belt and the slat between the shaped insert and the fasteners.

### CROSS-REFERENCE TO RELATED APPLICATIONS

Not applicable.

### FIELD

Embodiments of the present disclosure relate generally to combine harvesters, and in particular to the feederhouse used to deliver crop material to the threshing system of the combine harvester, and more particularly to the belt arrangement within the feederhouse.

### BACKGROUND

A combine harvester typically includes a crop cutting head and a threshing system for detaching grains of cereal from the ears of cereal. A delivery system delivers the cut crop to the threshing system, known as the feederhouse. A separating apparatus is downstream of the threshing system, and a grain cleaning apparatus receives grain from the separating apparatus. A stratification pan aims to stratify the material into a layered structure of grain at the bottom and light chaff and other material other than grain (MOG) at the top.

There are various designs for the threshing system and for the separating apparatus (e.g. axial or transverse) as well as for the grain cleaning apparatus. However, in all designs, there is a flow of material from the threshing system to the separating apparatus, and between the separating apparatus and the grain cleaning unit.

The feederhouse is one of the limiting performance factors of modern large combines and there is therefore a continuing need for an improved feederhouse design.

The feederhouse is typically in the form of a set of conveyor chains or belts with cross bars or slats extending between pairs of chains or belts that transport the crop material within the feederhouse.

Belt arrangements are preferred to chain arrangements for the conveyor due to the noise generated by chain conveyors and the wear caused to the chain links during operation. The belts are typically formed of fibre reinforced elastomeric webbing. However, such belts are not without their own problems.

In particular, the attachment of the cross bars or slats extending between pairs of belts can be a point of failure.

### BRIEF SUMMARY

According to a first aspect of the present invention, a coupling arrangement between a slat and an endless belt for a feederhouse feed conveyor of an agricultural harvester comprises:
the endless belt having a plurality of integrally formed teeth on a first side of the belt and
the slat having first and second laterally aligned openings at each end; wherein
at least one of the plurality of teeth is formed with a shaped recess; and
the coupling arrangement further comprises
first and second belt openings extending from the shaped recess to a second side of the belt, each of the first and second belt openings being aligned with the first and second slat openings;
a shaped insert located within the shaped recess and
fasteners securing the belt and the slat between the shaped insert and the fasteners.

Preferably, the shaped insert comprises first and second threaded insert openings aligned with the first and second belt openings and the fasteners comprise first and second bolts extending through the first and second threaded insert openings and the first and second belt openings to engage with the first and second threaded insert openings.

Alternatively, the shaped insert comprises first and second feet spaced to align with the first and second belt openings, free ends of the first and second feet being provided with threaded portions and the fasteners comprise first and second nuts to engage with the threaded portions of the first and second feet.

Preferably, each of the first and second feet comprises a first portion of a larger diameter and a second portion of smaller diameter. More preferably the larger diameter of the first portion of each foot corresponds to a diameter of the belt openings. Preferably the threaded portions of the first and second feet correspond to the second portions of smaller diameter.

According to a second aspect of the invention, a feederhouse belt assembly comprises a plurality of feederhouse belts, including at least one coupling arrangement according to the first aspect of the present invention, and a drive arrangement for the feederhouse belts and a plurality of slats fixed to and between adjacent feederhouse belts, each of the slats extending laterally between a pair of feederhouse belts.

According to a third aspect of the present invention, a combine harvester comprises a crop cutting head; a feederhouse belt assembly according to the second aspect of the invention; a threshing system; a separating system; and a grain cleaning system for receiving the cut and threshed crop material.

Within the scope of this application it should be understood that the various aspects, embodiments, examples and alternatives set out herein, and individual features thereof may be taken independently or in any possible and compatible combination. Where features are described with reference to a single aspect or embodiment, it should be understood that such features are applicable to all aspects and embodiments unless otherwise stated or where such features are incompatible.

### BRIEF DESCRIPTION OF THE DRAWINGS

The invention will now be described, by way of example only, with reference to the accompanying drawings, in which:

FIG. 1 shows a schematic side view of a known combine harvester;

FIG. 2 shows a perspective view of elements of a known belt coupling;

FIG. 3 shows a schematic perspective view of first and second examples of a coupling between a slat and an endless belt;

FIG. 4 shows a sectional view of the first and second examples shown in FIG. 3;

FIG. 5 shows a first exploded view of the first and second examples shown in FIG. 3;

FIG. 6 shows a second exploded view of the first and second examples shown in FIG. 3;

FIG. 7 shows a perspective view of a belt for use in the first and second examples shown in FIG. 3;

FIG. 8 shows a perspective view of one end of a slat fully coupled to a belt;

FIG. 9 shows a sectional perspective view of the first example of a coupling between a slat and an endless belt;

FIG. 10 shows a sectional perspective view of the second example of a coupling between a slat and an endless belt;

FIG. 11 shows a perspective view of elements of a feederhouse belt arrangement;

FIG. 12 shows a perspective view of a belt for use in a third example of a coupling between a slat and an endless belt;

FIG. 13 shows a perspective view of one end of a slat fully coupled to a belt;

FIG. 14 shows an exploded view of the third example shown in FIG. 12; and

FIG. 15 shows a sectional perspective view of the third example shown in FIG. 12.

### DETAILED DESCRIPTION

The invention will now be described in the following detailed description with reference to the drawings, wherein preferred embodiments are described in detail to enable practice of the invention. Although the invention is described with reference to these specific preferred embodiments, it will be understood that the invention is not limited to these preferred embodiments. But to the contrary, the invention includes numerous alternatives, modifications and equivalents as will become apparent from consideration of the following detailed description.

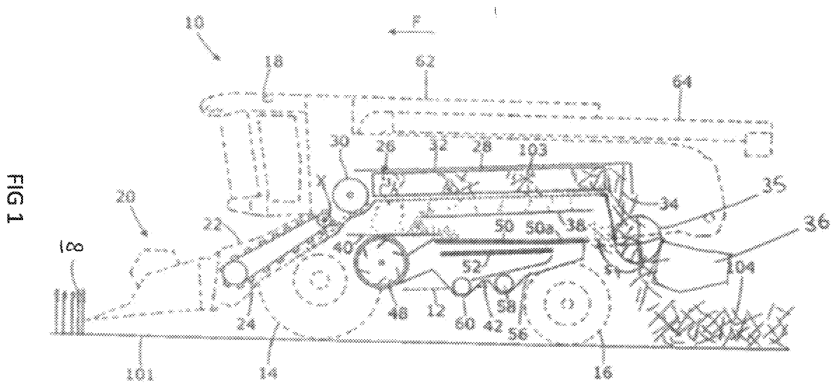

Relative terms such as forward, rearward, transverse, lateral, longitudinal and sideways will be made with reference to the normal forward direction of travel of the combine 10 and indicated by arrow F represented in FIG. 1. The terms vertical and horizontal will be made with reference to the level ground 101 upon which the combine 10 is disposed. In other words the Cartesian axes of ‘longitudinal’, ‘transverse’, and ‘vertical’ are made in relation to the chassis 12 of combine 10 and are not affected by any slope in the ground. The terms “upstream” and “downstream” are made with reference to the general direction of crop flow along the material conveyance systems described.

FIG. 1 illustrates in schematic form the main components of the crop processing system of a combine harvester 10 and will be used to explain the flow of material below. The crop processing system is shown in solid lines whilst the outline profile of harvester 10 is shown in ghost form.

Combine harvester 10, hereinafter referred to as ‘combine’, includes a chassis 12 supported on front wheels 14 and rear steerable wheels 16 which engage the ground 101. A driver's cab 18 is also supported on the chassis 12 and houses a driver's station from where a driver controls the combine 10.

A cutting header 20 is detachably supported on the front of a feeder house 22 which is pivotable about a transverse axis x to lift and lower the header 20 in a conventional manner.

The combine 10 is driven in a forward direction (arrow F) across a field of standing crop 100 in a known manner. The header 20 serves to cut and gather the standing crop material before conveying such as a crop material stream into feeder house 22. An elevator 24, normally in the form of a chain and slat conveyor or elevator as shown, is housed within the feeder house 22 and serves to convey the crop material stream upwardly and rearwardly from the header 20 to the crop processor designated generally at 26. At this stage the crop material stream is unprocessed.

The crop processor 26 of the illustrated combine 10 includes a pair of axial flow threshing and separating rotors 28 fed by a tangential flow, crop material impelling, feed beater 30. It should be appreciated however that alternative types of crop processor may be used without deviating from the scope of the invention. For example, the crop processor may instead include a conventional tangential flow threshing cylinder with a plurality of straw walkers for separation. Alternatively, a single axial-flow processing rotor may be employed.

The feed beater 30 rotates on a transverse axis and comprises crop engaging deflectors (not shown) which convey the crop material stream under the beater and into rotor housings 32 which each house one of said rotors 28. It should be appreciated that only the left-hand rotor 28 and housing 32 is shown in FIG. 1 whereas the right-hand equivalent is hidden from view.

The rotors 28 are positioned to have a generally longitudinal, or fore and aft, rotation axis which is normally inclined upwardly towards the rear of the combine 10.

Flighting elements (not shown) provided on the front end of each rotor 28 engage the crop material stream which is then conveyed as a ribbon or mat 103 in a generally rearward axial and helical path in the space between the rotor 28 and the rotor housing 32.

The axial flow rotors 28 serve to thresh the crop stream in a front region, separate the grain therefrom in a rear region, and eject the straw residue via a straw discharge chute 34 provided below a rear portion of the rotors 28, the straw falling either directly onto the ground in a windrow, or via a straw chopper 35 and straw spreader 36 to be described in more detail later.

A part-cylindrical grate or concave 37 provided in the underside of each rotor housing 32 allows the separated material to fall by gravity onto either a return pan 38 located below a rear section of the processor 26, or directly onto a stratification pan 40 located below a front section of the processor 26. In reality, the separated material falling through the grate 37 is typically a mix of grain and material other than grain (MOG) which may include chaff, tailings and some straw.

The return pan 38 and stratification pan 40 together serve as a material conveyance system arranged to convey the separated crop material to a grain cleaning shoe designated generally at 42. The pans 38,40 each include a respective linkage (not shown) to convert a torque source into oscillating motion to oscillate the pans in a generally fore and aft direction. Combined with a transversely rippled or corrugated floor, the oscillating movement of the return pan 38 and stratification pan 40 propels the material generally forwardly or rearwardly respectively.

The return pan 38 “returns” the separated material incident thereon towards the front of the combine 10 (in the direction F) to a front discharge edge 44 from where the material falls or cascades onto the stratification pan 40. The material on the stratification pan 40 is conveyed rearwardly to a rear discharge edge 46 from where the material falls into the cleaning system or “shoe” 42.

The grain-MOG mix falls from the rear discharge edge 46 into the cleaning shoe 42 where the cascading mix is subjected to a cleaning airstream generated by fan 48, before falling onto the front of upper sieve or chaffer 50.

Chaffer 50 comprises adjustable louvres supported on a frame which is driven in fore-and-aft oscillating manner. The material which settles on the chaffer 50 is conveyed in a generally rearward direction and the heavier smaller grain-rich material passes between the louvres onto an underlying lower sieve 52, whereas the lighter larger material (mostly chaff) passes to the end of the chaffer and out of the rear of the machine at shoe outlet 54. A rear section of chaffer 50a is commonly independently adjustable and is configurable to allow tailings to pass there through into a re-threshing region 56 from where the tailings are conveyed via a re-threshing auger 58 back to the processor 26.

Lower sieve 52 is also driven in an oscillating manner to convey the collected grain-MOG mix rearwardly wherein the material falling there through is collected by a clean grain auger 60 for conveyance to an elevator (not shown) for onward conveyance to a grain tank 62. Material which does not pass through lower sieve 52 and is instead conveyed off the rear edge thereof falls into re-threshing region 56 for subsequent re-threshing.

The airstream generated by fan unit 48 is also conveyed by ducting up through lower sieve 52 and chaffer 50 to encourage lifting of the MOG from the chaffer surface.

For completeness the combine 10 includes an unloading system which includes an unloading auger 64.

The conveyor typically comprises a laterally extending front shaft extending through the sidewalls of the housing at the front of the feederhouse where it couples to the agricultural harvesting head and a laterally extending rear shaft that extends through the sidewalls of the housing at the rear of the housing where it couples to the combine. Typically, four endless belts extend around these two shafts, typically on toothed sprockets. The inner side of each endless belt is provided with recesses into which drive pins of the sprockets become seated to drive the belts.

Slats are fixed to and between the belts and extend laterally, generally parallel to the two shafts. It is also known to use three endless belts extending around the front and rear shafts to support the slats.

Aspects of the invention relate to the design of an improved arrangement for the belt drive of a feederhouse of a combine harvester and, in particular, to the coupling of the slats to the endless belts.

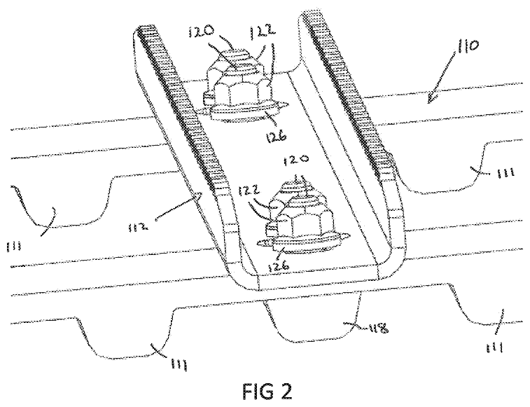

A known coupling is shown in FIG. 2. Belts 110 for use in the belt drive of a feederhouse of a combine harvester typically comprises a strip or web of fabric material, such as a polymer fabric.

A belt 110 is provided on a first side with spaced formed teeth 111 for engagement with toothed sprockets. The teeth 111 may be moulded on formation of the belt 110 or subsequently machined to a desired shape following moulding of the belt 110. In use, the first side of the belt is the inside of the endless belt 110. At intervals along the belt 110, where a slat 112 is to be connected, the formed tooth is omitted and instead the belt is formed with first and second openings 114,116 arranged transversely across the belt 110. A formed insert 118 is provided having a body portion, sized and shaped to match with the formed teeth of the belt 110. First and second feet 120 extend from the formed insert 118, the feet 120 being sized and shaped to extend through the openings 114,116 in the belt 110. The slats 112 are provided at each end with a series of openings, including openings 124 spaced to receive the free ends of the feet 120 extending through the belt 110. The free ends of the feet 120 are conveniently provided with threaded portions such that nuts 122 may be screwed onto the free ends of the feet to secure the slat 112 and the formed insert 118 in position. Conveniently, a washer 126 may be located between each of the nuts and the adjacent slat 112.

While the formed insert 118 may be formed in any convenient manner, it generally comprises a different material to the belt teeth 111. In practice, this is often a material that wears faster than, that is has reduced durability compared to the formed teeth 111 of the belt 110.

It will be appreciated that, in use, the forces acting on the slats may cause the threaded portions to be stripped resulting in loosening of the slats and a loss of efficiency in the operation of the feederhouse belt drive. In extreme cases one ends of the slats may become separated from the formed insert. This is highly undesirable as when separated a stripped nut or the formed insert may become introduced into the downstream crop flow. Additionally, operation of the combine harvester will need to be halted while the feederhouse is accessed to replace the slat and formed insert, in some cases requiring replacement of the entire feederhouse belt drive.

It is an advantage of the present invention that a more robust connection is provided. Further the invention makes use of existing slats so no redesign of these parts is required.

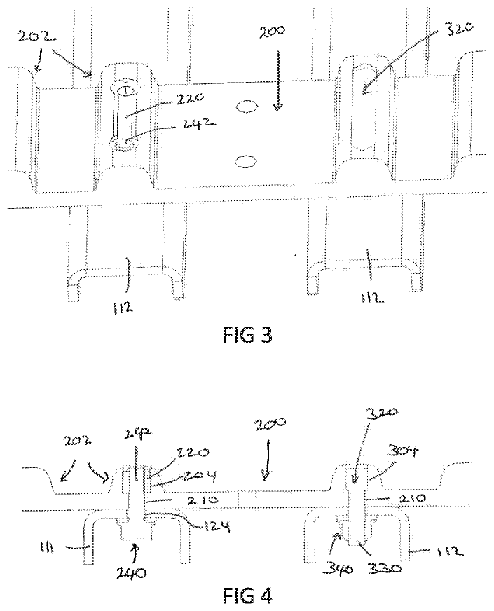

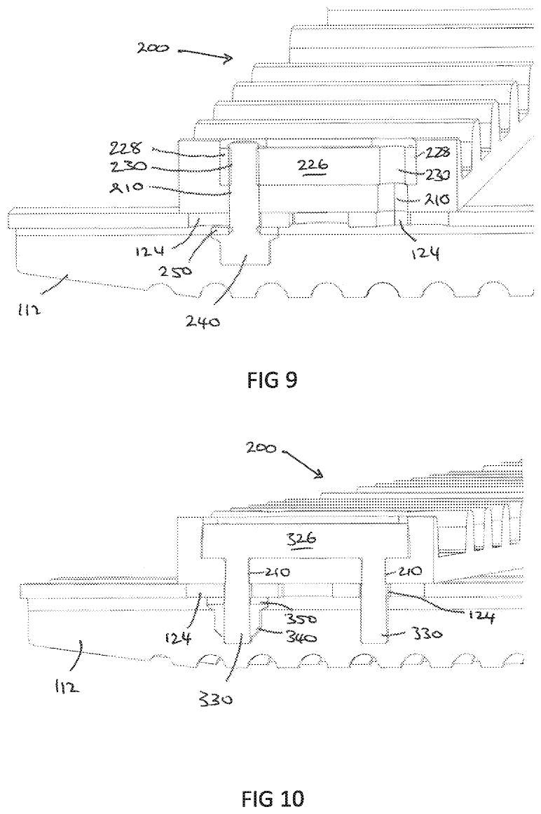

First and second examples of a coupling arrangement between a slat and a belt are shown in FIGS. 3 to 7. The first example is shown in more detail in FIG. 9. The second example is shown in more detail in FIG. 10.

Referring first to the left hand side of FIGS. 3 to 8 and FIG. 9 a first example of a coupling arrangement is illustrated.

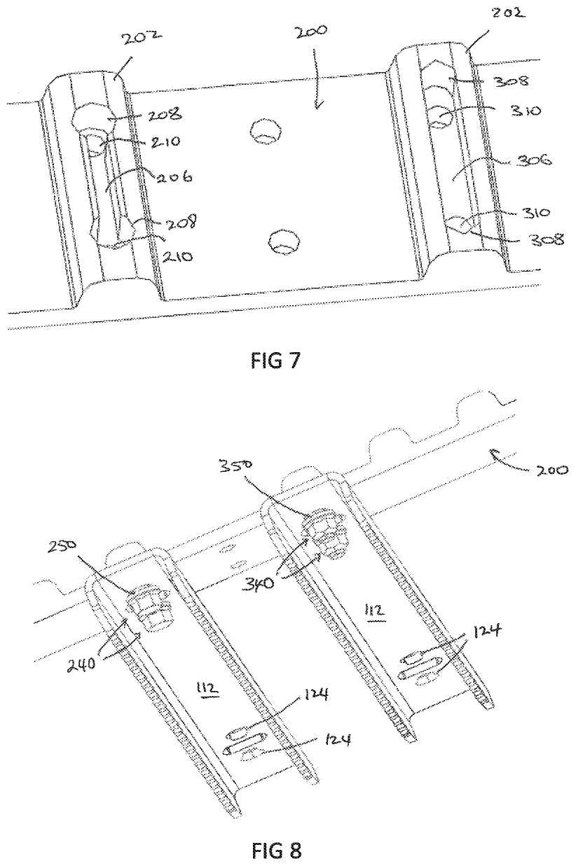

A belt 200 is provided on a first side with spaced formed teeth 202 for engagement with toothed sprockets. Where a slat 112 is to be secured to the belt 200, a formed tooth 202 is provided with a recess 204. The recess of the first example comprises a central straight channel 206 bounded at its ends with enlarged polygonal regions 208. At the base of the polygonal regions 208 are located openings 210 in the form of shaped through bores. The openings 210 may be of circular or shaped cross section (FIG. 7).

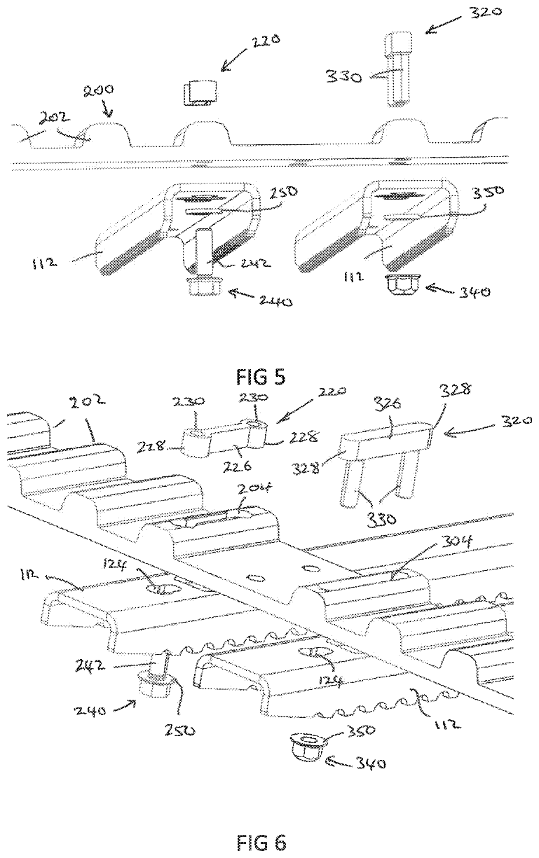

A shaped insert 220 is adapted to be seated with in the formed tooth recess 204. As may be best seen from FIG. 6, the shaped insert 220 comprises a linear central portion 226 bounded at each end by bulbous regions 228. Each of the bulbous regions is provided with a threaded through bore 230.

The linear central portion 226 of the insert 220 is adapted to be seated in the central straight channel 206 of the formed tooth 202 such that the bulbous regions of the insert 220 are received within the enlarged polygonal regions 208 of the recess 204 (FIG. 3) such that the openings 210 of the belt 200 are axially aligned with the through bores 230 in the insert 220 (FIG. 4).

In use, a slat is located adjacent the formed tooth 202 and insert 220, such that the slat openings 118 are aligned with the belt openings 210. Threaded fasteners 240 are utilised to secure the slat 112, belt 200 and insert 226 together. Each threaded fastener 240 has a shank 242 passed through a slat opening 118 and a belt opening 210 to engage the threaded through bore 230 of the insert 226. The threaded fastener 240 is tightened to draw the slat 112, belt 200 and insert 226 together. Conveniently a washer 250 may be located between a head of each threaded fastener 240 and the slat 112.

A second example of a coupling arrangement is illustrated in the right hand side of FIGS. 3 to 8 and in FIG. 10.

Where a slat 112 is to be secured to the belt 200, a formed tooth 202 is provided with a recess 304. The recess of the second example comprises a central straight channel 306 bounded at its ends with polygonal regions 308. At the base of the polygonal regions 308 are located openings 210 in the form of shaped through bores. The openings 210 may be of circular or shaped cross section (FIG. 7).

A shaped insert 320 is adapted to be seated with in the formed tooth recess 304. As may be best seen from FIG. 6, the shaped insert 320 comprises a linear central portion 326 bounded at each end by polygonal regions 328. First and second projections or feet 330 extend from a lower side of the shaped insert 320 (FIGS. 6 & 9), the feet 320 being sized and shaped to extend through the openings 210 in the belt 200.

The linear central portion 326 of the insert 320 is adapted to be seated in the central straight channel 306 of the formed tooth 202 such that the polygonal end regions of the insert 320 are received within the polygonal end regions 308 of the recess 304 (FIG. 3) such that feet 330 extend though the openings 210 of the formed tooth 202 (FIG. 4).

In use, a slat 112 is located adjacent the formed tooth 202 and insert 320, such that the slat openings 124 are aligned with the belt openings 210 and the feet 330, and the free ends of the feet 330 extend though the slat openings 124. A free end of each of the feet 320 is conveniently provided with a threaded portion onto which a threaded fastener in the form of a nut 340 may be threaded. Each nut 340 is tightened to draw the slat 112, belt 100 and insert 320 together. Conveniently a washer 350 may be located between each nut 340 and the slat 112.

In each example, the coupling arrangement between the slat 112 and the belt 200 is made in a thickened region of the belt 200 better able to withstand the pressures of the operating environment. Further, by locating the less durable insert 220,320 within a formed tooth 202, the formed tooth 202 having the coupling with the slat 112 is more durable than the prior construction of FIG. 2.

FIG. 8 shows the coupling arrangement with both fasteners 240,340 secured.

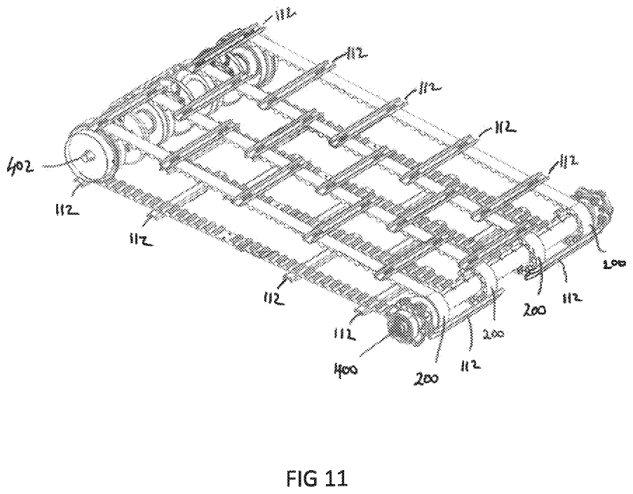

FIG. 11 shows an example belt arrangement for the conveyor. The illustrated conveyor comprises a laterally extending front shaft 400 extending through the sidewalls of a housing at the front of the feederhouse where it couples to the agricultural harvesting head and a laterally extending rear shaft 402 that extends through the sidewalls of the housing at the rear of the housing where it couples to the combine. In the illustrated example, four endless belts 200 extend around these two shafts 400,402, typically on toothed sprockets, each slat 112 being secured at its ends by a coupling arrangement in accordance with the present invention.

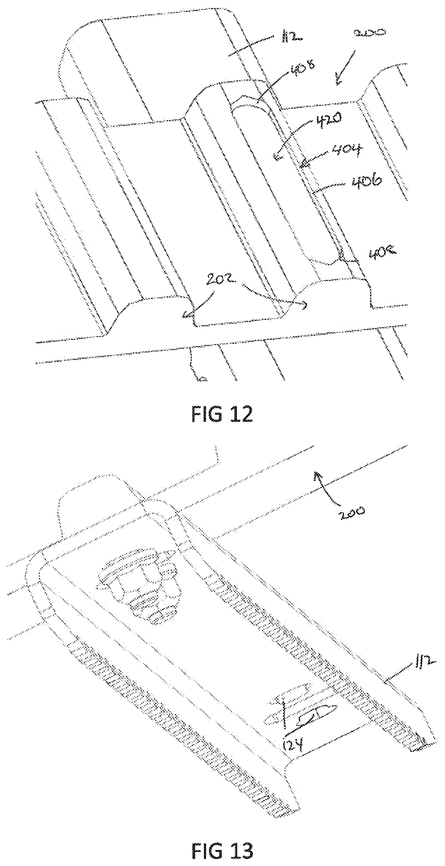

A third example of a coupling arrangement between a slat and a belt are shown in FIGS. 12 to 15.

Where a slat 112 is to be secured to a belt 200, a formed tooth 202 is provided with a recess 404. The recess of the third example is of same form as that of the second example, namely a central straight channel 406 bounded at its ends with polygonal regions 408. At the base of the polygonal regions 408 are located openings 410 in the form of shaped through bores. The openings 410 may be of circular or shaped cross section.

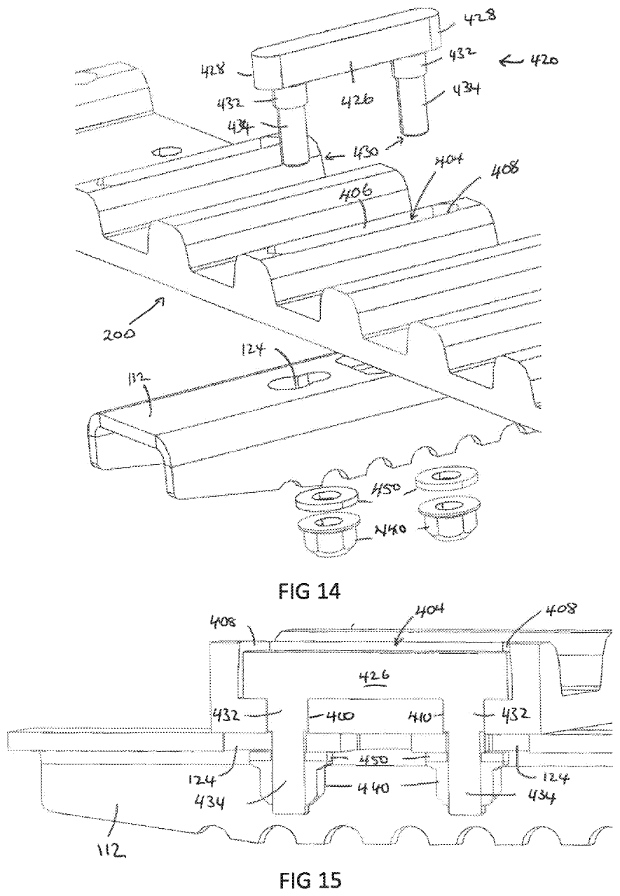

A shaped insert 420 is adapted to be seated with in the formed tooth recess 404. As may be best seen from FIG. 14, the shaped insert 420 comprises a linear central portion 426 bounded at each end by rounded regions 428. Alternatively, the end regions may be polygonal as in the second example. First and second projections or feet 430 extend from a lower side of the shaped insert 420 (FIGS. 14 & 15).

In this example, each of the first and second feet 430 comprises a first portion 432 of a larger diameter and a second portion 434 of smaller diameter. The belt openings 410 of this example are formed of greater diameter than those of the first and second examples. The larger diameter of the first portion 432 of each foot 430 corresponds to a diameter of these belt openings 410.

The linear central portion 426 of the insert 420 is adapted to be seated in the central straight channel 406 of the formed tooth 202 such that the rounded end regions of the insert 420 are received within the end regions 408 of the recess 404 (FIG. 3) such that the feet 430 extend though the openings 210 of the belt 200 (FIG. 12).

In use, a slat 112 is located adjacent the formed tooth 202 and insert 420, such that the slat openings 124 are aligned with the belt openings 210 and the feet 430 of the insert 420, such that a first portion 432 of each foot 430 is seated in a belt opening 210 and a second portion 434 of each foot 432 extends though the slat openings 124. The second portions 434 of each of the feet 420 are conveniently provided with a threaded portion onto which a threaded fastener in the form of a nut 440 may be threaded. Each nut 440 is tightened to draw the slat 112, belt 100 and insert 420 together. Conveniently a washer 450 may be located between each nut 440 and the slat 112.

As in the first and second examples, the coupling arrangement between the slat 112 and the belt 200 is made in a thickened region of the belt 200 better able to withstand the pressures of the operating environment. Further, by locating the less durable insert 420 within a formed tooth 202, the formed tooth 202 having the coupling with the slat 112 is more durable than the prior construction of FIG. 2. Additionally, the increased diameter of the first portions 432 within the larger belt openings 410 should enable greater torque to be applied by the nut 440 against the slat 112. This is intended to help prevent deformation of the belt 200 in use.

All references cited herein are incorporated herein in their entireties. If there is a conflict between definitions herein and in an incorporated reference, the definition herein shall control.

From reading the present disclosure, other modifications will be apparent to persons skilled in the art. Such modifications may involve other features which are already known in the field of combine harvesters and component parts therefore and which may be used instead of or in addition to features already described herein.

What is claimed is:

1. A coupling arrangement between a slat and an endless belt for a feederhouse feed conveyor of an agricultural harvester, the endless belt having a plurality of integrally formed teeth on a first side of the belt and the slat having first and second laterally aligned openings at each end, wherein at least one of the plurality of teeth is formed with a shaped recess, and wherein the coupling arrangement further comprises:
first and second belt openings extending from the shaped recess to a second side of the belt, each of the first and second belt openings being aligned with the first and second slat openings;
a shaped insert located within the shaped recess and fasteners securing the belt and the slat between the shaped insert and the fasteners.

2. A coupling arrangement according to claim 1, wherein the shaped insert comprises first and second threaded insert openings aligned with the first and second belt openings and the fasteners comprise first and second bolts extending through the first and second threaded insert openings and the first and second belt openings to engage with the first and second threaded insert openings.

3. A coupling arrangement according to claim 1, wherein the shaped insert comprises first and second feet spaced to align with the first and second belt openings, free ends of the first and second feet being provided with threaded portions and the fasteners comprise first and second nuts to engage with the threaded portions of the first and second feet.

4. A coupling arrangement according to claim 3, wherein each of the first and second feet comprises a first portion of a larger diameter and a second portion of smaller diameter.

5. A coupling arrangement according to claim 4, wherein the larger diameter of the first portion of each foot corresponds to a diameter of the belt openings.

6. A coupling arrangement according to claim 4, wherein the threaded portions of the first and second feet correspond to the second portions of smaller diameter.

7. A coupling arrangement according to claim 5, wherein the threaded portions of the first and second feet correspond to the second portions of smaller diameter.

8. A feederhouse comprising a plurality of feederhouse belts, including at least one belt and slat coupling arrangement according to claim 1, a drive arrangement for the feederhouse belts and a plurality of slats fixed to and between adjacent feederhouse belts, each of the slats extending laterally between a pair of feederhouse belts.

9. A combine harvester comprising:
a crop cutting head;
a feederhouse according to claim 8;
a threshing system;
a separating system; and
a grain cleaning system for receiving the cut and threshed crop material.
